(19) United States
(12) Patent Application Publication
(10) Pub. No.: US 2016/0345783 A1
(43) Pub. Date: Dec. 1, 2016

(54) ARTICLE FOR CARRYING FOOD CONTAINERS

(71) Applicant: World Brands Inc., St. Petersburg, FL (US)

(72) Inventor: Önder Nehir, Istanbul (TR)

(73) Assignee: World Brands Inc., St. Petersburg, FL (US)

(21) Appl. No.: 14/926,457

(22) Filed: Oct. 29, 2015

(30) Foreign Application Priority Data
May 26, 2015 (TR) 2015/06360

(51) Int. Cl. A47J 47/14; B65D 30/28; B65D 33/08

(52) U.S. Cl. CPC A47J 47/14; B65D 33/08; B65D 31/18

(57) ABSTRACT

An article for manually carrying one or more food containers is disclosed. The article includes a base, a first side portion connected to the base along a first side fold, a second side portion connected to the base along a second side fold, and at least one handle connected to or otherwise associated with at least one of the first side portion or the second side portion. The base, the first side portion, and the second side portion may form a triangular shape with open sides for positioning the one or more food containers onto the base between the first side portion and the second side portion.

### CROSS-REFERENCE TO RELATED APPLICATIONS

The disclosure claims priority to and the benefit of Turkish utility model patent application No. 10024, filed 1 Jun. 2015, entitled “PAPER BAG USED IN THE CARRYING OF FOOD BOXES,” which is herein incorporated by reference in its entirety.

### FIELD OF THE DISCLOSURE

The disclosure generally relates to food transportation and more particularly relates to a bag or other article to assist in manually carrying one or more food containers.

### BACKGROUND

Many types of foods are produced in restaurants, bakeries, and the like, which then are placed in boxes or other take-away containers for transport by delivery personnel and/or by the customer. For example, pizzas often are transported in paperboard or cardboard boxes. In many instances, the boxes must be carried in an orientation which preserves the form of the food during transport, e.g., with the base of the box remaining substantially horizontal. Often multiple boxes are stacked together for transport. Some boxes, such as large pizza boxes or stacks of smaller boxes, may be cumbersome to carry, particularly without a person needing to use both hands. In addition, carrying such boxes by hand may result in fatigue and/or dropped boxes, which may cause the food to be spilled or its form altered undesirably.

Therefore, a need exists for convenient and better ways to manually carry one or more pizza boxes and/or other food containers.

### SUMMARY

Some or all of the above needs and/or problems may be addressed by embodiments of the article for carrying one or more food containers disclosed herein. The article includes or consists of a base, a first side portion connected to the base along a first side fold, a second side portion connected to the base along a second side fold, and at least one handle connected to or otherwise associated with at least one of the first side portion or the second side portion. The base, the first side portion, and the second side portion may form a triangularly shaped bag with open sides for positioning the one or more food containers onto the base between the first side portion and the second side portion.

Other features and aspects of the article will be apparent or will become apparent to one with skill in the art upon examination of the following figures and the detailed description. All other features and aspects, as well as other system, method, and assembly embodiments, are intended to be included within the description and are intended to be within the scope of the accompanying claims.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts an article for carrying one or more food containers in accordance with one or more embodiments of the disclosure.

FIG. 2 schematically depicts an article for carrying one or more food containers in accordance with one or more embodiments of the disclosure.

FIG. 3 schematically depicts an article for carrying one or more food containers in accordance with one or more embodiments of the disclosure.

FIG. 4 schematically depicts another version of an article for carrying one or more food containers in accordance with embodiments of the present disclosure.

FIG. 5 schematically depicts another version of an article for carrying one or more food containers in accordance with embodiments of the present disclosure.

### DETAILED DESCRIPTION

Described below are embodiments of systems, methods, and articles for conveniently carrying one or more food containers. In certain embodiments, the article includes a base, a first side portion, and a second side portion. The first side portion may be connected to the base along a first side fold, and the second side portion may be connected to the base along a second side fold. In some instances, the base, the first side portion, and the second side portion comprise a single unitary structure.

Advantageously, the carrying article, which may be considered a type of bag, has two opposed open sides between the first and second side portions, which facilitate the convenient loading of food containers into the carrying article while maintaining the desired orientation of the food container, such as a pizza box, a cake box, and other food containers or the like. In contrast, for example, a conventional paper bag which has four side walls and an opening only at the top may be difficult or impossible to load with a pizza box without having to turn the pizza box on its side, or without having to turn and carry the bag with its opening facing sideways, negating the ability to use any handles the bag may have.

In a preferred embodiment, the base, the first side portion, and the second side portion are formed of unitary sheet of paper, such as a kraft paper, or other paper material known in the art. The paper may be of various suitable basis weights. In another embodiment, the base, the first side portion, and the second side portion are formed of unitary sheet of a flexible but sturdy plastic. Other materials of construction may be used.

At least one handle may be connected to, or defined in, the first side portion, the second side portion, or a combination thereof. In a preferred embodiment, the article includes a first handle attached to an end of the first side portion opposite the first side fold, a second handle attached to an end of the second side portion opposite the second side fold, or a combination thereof. Any number of handles may be used herein. The handle may be made of paper, a synthetic material, or of woven or twisted fibers, for example in the form of a string, rope, yarn, or cord. Other materials of construction may be used. The handle(s) may attached to the first and/or second side portions by any of a variety of means known in the art, include adhesives, or mechanical fasteners.

In some instances, the handle(s) comprise a cutout in the first side portion, the second side portion, or both. For example, an end of the first side portion opposite the first side fold and an end of the second side portion opposite the second side fold each may include a cutout forming a handle.

In certain embodiments, the base, the first side portion, and the second side portion are connected and configured to form a substantially triangular shape with open sides for positioning the one or more food containers therein. In some instances, the first handle and the second handle are brought together by a user to form the substantially triangular shape. For example, the one or more food containers may be placed onto the base between the first side fold and the second side fold, and the first handle and the second handle may be brought together by a user to form the substantially triangular shape. In other instances, the one or more food containers are slid through the side openings onto the base between the first side portion and the second side portion after the first handle and the second handle are brought together to form the substantially triangular shape.

In another embodiment, an end of the first side portion opposite the first side fold is attached to an end of the second side portion opposite the second side fold to form the substantially triangular shape with open sides for positioning the one or more food containers therein. For example, the one or more food containers may be slid through the side openings onto the base between the first side portion and the second side portion. In this manner, a user may grasp the one or more handles to carry the article with the one or more food containers positioned therein.

In certain embodiments, at least a portion of the first side portion and the second side portion frictionally engage a portion of the one or more food containers for securing the one or more food containers therebetween. That is, in some instances, an inner wall of the first side portion, the second side portion, or a combination thereof may press against an upper corner of the one or more food containers.

A middle fold may be disposed along a center of the base between the first side fold and the second side fold. In this manner, the article may be folded and unfolded between a folded configuration and an unfolded configuration. For example, the middle fold may be folded between the first side portion and the second side portion, and the first side fold and the second side fold may be folded and brought together in the folded configuration. The unfolded (i.e., deployed) configuration may include the triangular shape formed between the base, the first side portion, and the second side portion. One or more additional folds may be disposed along the first side portion and the second side portion for folding the at least one handle.

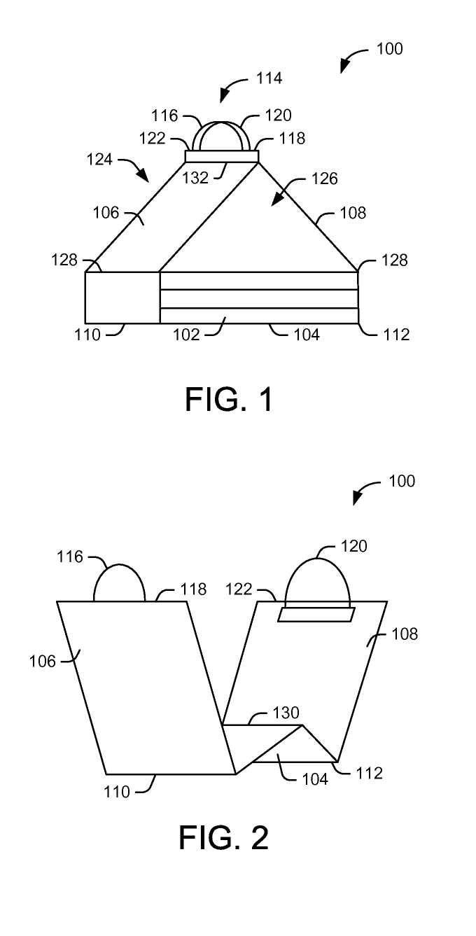

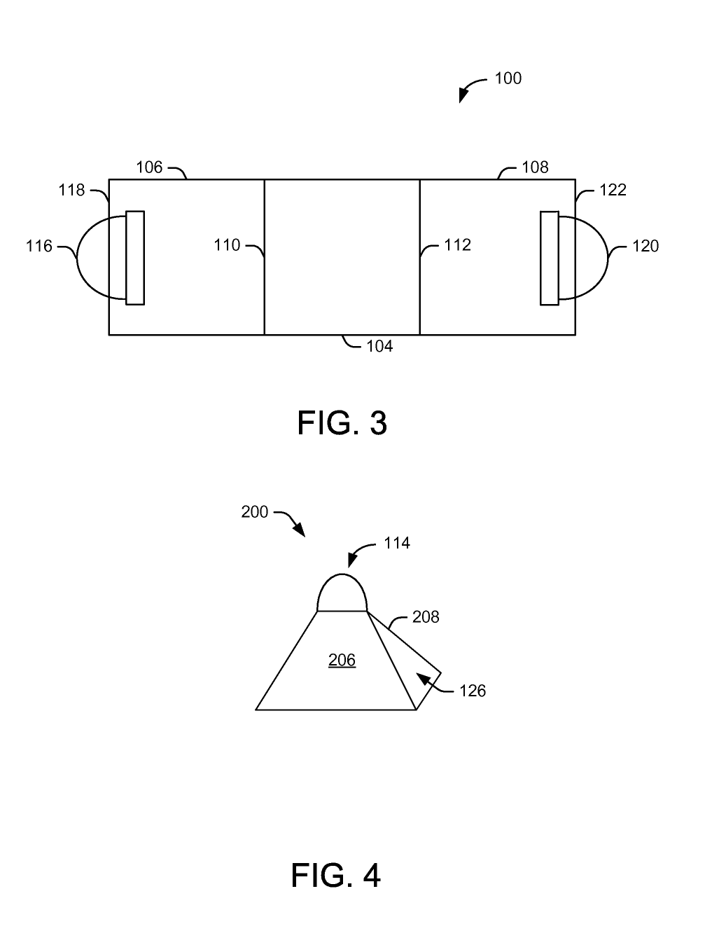

FIGS. 1-3 schematically depict an article 100 for carrying one or more food containers 102, such as boxes or the like. In some instances, the one or more food containers 102 may be stacked together and carried within the article 100. In other instances, a single food container 102 may be carried within the article 100. Any type of container, including pizza boxes and other food and non-food containers, may be carried by the article 100. If two or more food containers 102 are carried, they may be of the same size or different sizes.

In certain embodiments, the article 100 comprises a base 104, a first side portion 106, and a second side portion 108. The base 104, the first side portion 106, and the second side portion 108 may be substantially rectangular in shape. In some instances, the base 104, the first side portion 106, and the second side portion 108 comprise a single unitary structure. In other instances, the base 104, the first side portion 106, and the second side portion 108 may comprise separate pieces interconnected together with one or more joints (e.g., hinges or the like) along one or more fold lines. In certain embodiments, the base 104, the first side portion 106, and the second side portion 108 are formed of a kraft paper or other suitable paper material.

In one embodiment, the first side portion 106 is connected to the base 104 along a first side fold 110, and the second side portion 108 is connected to the base 104 along a second side fold 112. The first side fold 110 and the second side fold 112 may form the ends of the base 104. The first side portion 106 may be folded relative to the base 104 along the first side fold 110, and the second side portion 108 may be folded relative to the base 104 along the second side fold 112.

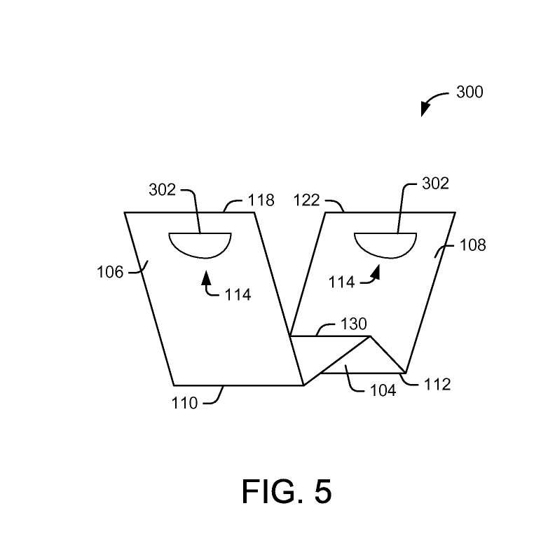

At least one handle 114 is connected to the first side portion 106, the second side portion 108, or a combination thereof. Any number of handles may be included. In a preferred embodiment, the article includes two opposed handles, each attached to one of the first and second side portions. For example, the at least one handle 114 may comprise a first handle 116 attached to an end 118 of the first side portion 106 opposite the first side fold 110, a second handle 120 attached to an end 122 of the second side portion 108 opposite the second side fold 112, or a combination thereof. The at least one handle 114 is configured (e.g., positioned, sized, and constructed) to be used to manually carry the articles 100 in a loaded (or unloaded) state. In an alternate embodiment, as depicted in FIG. 5, the at least one handle 114 comprises a cutout 302 in the first side portion 106 and/or the second side portion 108. Other types of handles may be used.

In certain embodiments, the base 104, the first side portion 106, and the second side portion 108 are arranged to form a substantially triangular shape 124 (when viewed facing either of the opposed open sides) with open sides 126 for positioning the one or more food containers 102 therein. In some instances, the open sides 126 may be a pair of opposed, substantially triangular shaped openings 126 defining open sides for positioning the one or more food containers 102 onto the base 104 between the first side portion 106 and the second side portion 108.

In some instances, the first handle 116 and the second handle 120 may be brought together by a user to form the triangular shape 124. For example, the one or more food containers 102 may be placed onto the base 104 between the first side fold 110 and the second side fold 112, and the first handle 116 and the second handle 120 may be brought together by a user to form the triangular shape 124. In other instances, the one or more food containers 102 may be slid or otherwise inserted through the side openings 126 onto the base 104 between the first side portion 106 and the second side portion 108 after the first handle 116 and the second handle 120 are brought together to form the substantially triangular shape 124.

In another embodiment, the end 118 of the first side portion 106 opposite the first side fold 110 is attached to the end 122 of the second side portion 108 opposite the second side fold 112 to form the substantially triangular shape 124 with open sides 126 for positioning the one or more food containers 102 therein. For example, the one or more food containers 102 may be slid through the side openings 126 onto the base 104 between the first side portion 106 and the second side portion 108. In this manner, a user may grasp the at least one handle 114 to carry the article 100 with the one or more food containers 102 positioned therein.

In certain embodiments, at least a portion of the first side portion 106 and the second side portion 108 engage edge portions of the one or more food containers 102 for securing the one or more food containers 102 therebetween. For example, in some instances, an inner wall of the first side portion 106, the second side portion 108, or a combination thereof may press against an upper corner of the one or more food containers 102. In this manner, the inner wall of the first side portion 106 or the second side portion 108 may bend (or form an angle) at a contact point 128 with the one or more food containers 102.

A middle fold 130 may be disposed along a center of the base 104 between the first side fold 110 and the second side fold 112. In this manner, the article 100 may be folded and unfolded between a folded configuration and an unfolded configuration. In a preferred embodiment, the folded configuration is substantially flat, to facilitate bulk storage and transport of the articles. For example, as depicted in FIG. 2, the middle fold 130 is folded between the first side portion 106 and the second side portion 108, and the first side fold 110 and the second side fold 112 is folded and brought together in the folded configuration. The unfolded (i.e., deployed) configuration, as depicted in FIG. 1, includes the triangular shape 124 formed between the base 104, the first side portion 106, and the second side portion 108. One or more additional folds 132 may be disposed along the first side portion 106 and the second side portion 108 for folding the at least one handle 114 over the first side portion 106 or the second side portion 108.

In alternative embodiments, the first and second side portions have non-rectangular shapes. For example, the shape may be a triangle, square, pentagon, trapezoid, ellipse, circle, oval, or the like. The base may include different or similar shapes. Another embodiment of the article is shown in FIG. 4, which depicts article 200. Article 200 has a first side portion 206, and a second side portion 208, each of which is in the shape of an isosceles trapezoid.

Although specific embodiments of the disclosure have been described, numerous other modifications and alternative embodiments are within the scope of the disclosure. For example, any of the functionality described with respect to a particular article or component may be performed by another article or component. Further, while specific article characteristics have been described, embodiments of the disclosure may relate to numerous other article characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An article for use in manually carrying one or more food containers, the article comprising:
a base;
a first side portion connected to the base along a first side fold;
a second side portion connected to the base along a second side fold; and
at least one handle connected to, or defined within, at least one of the first side portion or the second side portion, wherein the base, the first side portion, and the second side portion together form a pair of opposed, substantially triangular shaped openings defining open sides for positioning the one or more food containers onto the base between the first side portion and the second side portion.

2. The article of claim 1, wherein at least a portion of the first side portion and the second side portion engage a portion of the one or more food containers for securing the one or more food containers therebetween.

3. The article of claim 1, further comprising a middle fold along a center of the base between the first side fold and the second side fold.

4. The article of claim 3, wherein the article comprises a folded configuration and an unfolded configuration.

5. The article of claim 4, wherein the middle fold is folded between the first side portion and the second side portion in the folded configuration, and wherein the first side fold and the second side fold are folded and brought together in the folded configuration.

6. The article of claim 4, wherein the unfolded configuration comprises the triangular shape formed between the base, the first side portion, and the second side portion.

7. The article of claim 1, wherein an end of the first side portion opposite the first side fold is attached to an end of the second side portion opposite the second side fold.

8. The article of claim 1, wherein the at least one handle comprises:
a first handle attached to an end of the first side portion opposite the first side fold; and
a second handle attached to an end of the second side portion opposite the second side fold.

9. The article of claim 1, wherein the at least one handle comprises:
a first cutout at an end of the first side portion opposite the first side fold; and
a second cutout at an end of the second side portion opposite the second side fold.

10. The article of claim 1, wherein the base, the first side portion, and the second side portion comprise a paper bag material.

11. The article of claim 1, further comprising one or more additional folds along the first side portion and the second side portion for folding the at least one handle.

12. The article of claim 1, wherein the base, the first side portion, and the second side portion comprise a single unitary structure.

13. An article for carrying one or more food containers, the article comprising:
a base comprising a middle fold along a center of the base;
a first side portion connected to the base along a first side fold;
a second side portion connected to the base along a second side fold, wherein an end of the first side portion opposite the first side fold is attached to an end of the second side portion opposite the second side fold; and
at least one handle associated with at least one of the first side portion or the second side portion, wherein the article comprises a folded configuration and an unfolded configuration, and wherein the base, the first side portion, and the second side portion form a triangular shape in the unfolded configuration comprising open sides for positioning the one or more food containers onto the base between the first side portion and the second side portion.

14. The article of claim 13, wherein at least a portion of the first side portion and the second side portion engage a portion of the one or more food containers for securing the one or more food containers therebetween.

15. The article of claim 13, wherein the middle fold is folded between the first side portion and the second side portion in the folded configuration, and wherein the first side fold and the second side fold are folded and brought together in the folded configuration.

16. The article of claim 13, wherein the unfolded configuration comprises the triangular shape formed between the base, the first side portion, and the second side portion.

17. The article of claim 13, wherein the at least one handle comprises:
a first handle attached to an end of the first side portion opposite the first side fold; and
a second handle attached to an end of the second side portion opposite the second side fold.

18. The article of claim 13, wherein the at least one handle comprises:
a first cutout at an end of the first side portion opposite the first side fold; and
a second cutout at an end of the second side portion opposite the second side fold.

19. The article of claim 13, wherein the base, the first side portion, and the second side portion comprise a paper bag material.

20. The article of claim 13, further comprising one or more additional folds along the first side portion and the second side portion for folding the at least one handle.

21. A method for producing an article for carrying one or more food containers, the method comprising:
providing a base;
forming a first side fold between a first side portion and the base;
forming a second side fold between a second side portion and the base; and
attaching to, or forming within, at least one of the first side portion or the second side portion, at least one handle, wherein the base, the first side portion, and the second side portion form a triangular shape with open sides for positioning the one or more food containers onto the base between the first side portion and the second side portion.

22. The method of claim 21, further comprising attaching an end of the first side portion opposite the first side fold to an end of the second side portion opposite the second side fold.

23. An article for carrying one or more food containers, the article comprising:
a base comprising a middle fold along a center of the base;
a first side portion connected to the base along a first side fold;
a second side portion connected to the base along a second side fold, wherein an end of the first side portion opposite the first side fold is attached to an end of the second side portion opposite the second side fold;
a first handle connected to the first side portion; and
a second handle connected to the second side portion,
wherein:
the article comprises a folded configuration and an unfolded configuration,
the base, the first side portion, and the second side portion together form a pair of opposed, substantially triangular shaped openings, in the unfolded configuration, defining open sides for positioning the one or more food containers onto the base between the first side portion and the second side portion, and
the base, the first side portion, and the second side portion are formed of paper.
